(19) United States
(12) Patent Application Publication
(10) Pub. No.: US 2026/0169833 A1
(43) Pub. Date: Jun. 18, 2026

(54) SYSTEM AND METHOD FOR EMBEDDING MACHINE-READABLE CALIBRATION AND MEASUREMENT CAPABILITY DATA INTO DCC

(71) Applicant: National Institute of Metrology, China, Beijing (CN)

(72) Inventors: Xingchuang Xiong, Beijing (CN); Yiwei Zhu, Beijing (CN); Zhengyi Zhao, Beijing (CN); Hao Gong, Beijing (CN); Wenkui He, Beijing (CN); Zhen Liu, Beijing (CN)

(21) Appl. No.: 19/333,331

(22) Filed: Sep. 18, 2025

(30) Foreign Application Priority Data
Dec. 16, 2024 (CN) 202411851799.5

(51) Int. Cl. G06F 9/54; G06F 21/64

(52) U.S. Cl. CPC G06F 9/546; G06F 21/64; G06F 2209/548; G06F 2221/2151

(57) ABSTRACT

Disclosed are a system and a method for embedding machine-readable calibration and measurement capability data into a DCC. The system includes a WEB service subsystem, an acquisition subsystem, a message queue subsystem and a storage subsystem, wherein the WEB service subsystem is connected to the acquisition subsystem through the message queue subsystem, and the storage subsystem is connected to both the WEB service subsystem and the acquisition subsystem. The present application regularly acquires the calibration and measurement capability (CMC) data from a BIPM website, embeds the CMC data into a relevant digital calibration certificate, and generates a trusted timestamp for the digital calibration certificate. The CMC data in the KCDB are regularly acquired and dynamically updated through API calling, so that a traditional manual query mode is replaced, manual intervention is remarkably reduced, the accuracy, effectiveness and authority of data use are improved, and the user experience is greatly improved.

### CROSS-REFERENCE TO RELATED APPLICATIONS

This application claims priority to Chinese Patent Application No. 202411851799.5, filed on Dec. 16, 2024, which is hereby incorporated by reference in its entirety.

### TECHNICAL FIELD

The present application belongs to the field of metrology, calibration and measurement, and in particular, to a system and a method for embedding machine-readable calibration and measurement capability data into a DCC (digital calibration certificate).

### BACKGROUND

Calibration and measurement capability (CMC) is a key component of the international metrology system. The accuracy, integrity, and authority of CMC data are of great significance to international trade, scientific research, and industrial development. The Bureau International des Poids et Mesures (BIPM) currently publishes globally recognized CMC data through the Key Comparison Database (KCDB), which contains information on the services provided by participating institutions through internationally recognized CMCs, as well as the core and supplementary comparison information supporting these CMCs. All data listed in the KCDB have been reviewed and approved under the Mutual Recognition Arrangement (MRA) of the CIPM, and are therefore also known as the CIPM MRA database. The CIPM MRA is a framework for the National Institute of Metrology (NIM) to demonstrate the international equivalence of NIM measurement standards and to achieve mutual recognition between calibration and measurement certificates issued by the NIM.

The CMC data in KCDB has been provided digitally by participating institutions since Oct. 29, 2019, and contents of the CMC data are accessed and controlled. In 2021, BIPM provided an application programming interface (API) for searching CMCs in KCDB. The API is accessible via the KCDB page on the BIPM website and is provided with an official manual (API KCDB Guide) explaining to a software developer how the API should be used. The goal of this initiative is to promote machine-readability of data in the BIPM database and to establish machine-readable formats for reference publications of the data. These machine-readable formats enable direct communication between machines. The data provided by the API KCDB is a response to search queries on the CMC.

Currently, calibration institutions have not developed widespread application of the machine-readable CMC data from the KCDB. In particular, the institutions capable of issuing DCCs have neither achieved efficient integration of the CMC data from the API KCDB into DCC systems nor established prior methods for embedding machine-readable CMC data into machine-readable DCCs. Users need to perform complex format conversion and data integration, which seriously limits the widespread application of DCCs in the field of metrology.

### SUMMARY

Aiming at the defects in the prior art, the present application provides a method for embedding machine-readable calibration and measurement capability data into a DCC, which solves the problem that the user actual experience is seriously influenced because the complex format conversion and data integration of the user are required in the prior art.

To achieve the above objective, the present application adopts the following technical solutions. A system for embedding machine-readable calibration and measurement capability data into a DCC includes a WEB service subsystem, an acquisition subsystem, a message queue subsystem and a storage subsystem, wherein the WEB service subsystem is connected to the acquisition subsystem through the message queue subsystem, and the storage subsystem is connected to both the WEB service subsystem and the acquisition subsystem;
the WEB service subsystem is configured to online view and manage calibration and measurement capability data, a digital calibration certificate, and trusted timestamp data;
the acquisition subsystem is configured to acquire data from a BIPM website, regularly acquire calibration and measurement capability data based on acquisition configuration, generate a digital calibration certificate based on an acquisition result, and affix a trusted timestamp;
the message queue subsystem is configured to perform asynchronous communication between the WEB service subsystem and the acquisition subsystem; and
the storage subsystem is configured to store information and data processed by the WEB service subsystem and the acquisition subsystem.

Further, the WEB service subsystem includes a WEB API service module, a user management module, and a business data management module;
the WEB API service module is deployed in a local area network, and the local area network is connected to a PC (personal computer) and is configured to provide a WEB page service for a user and provide a reverse proxy service of an interface for the user management module and the business data management module;
the user management module is configured to provide user management services, including user addition, deletion, modification and query, provide user login, logout and authentication services; and is also configured to acquire an authorization scheme based on Cookie and Session and provide an authorized user with access to corresponding data resource services; and
the business data management module is configured to provide management services for business data, including query and deletion of calibration and measurement capability data, query and deletion of digital calibration certificate data, and query of a trusted timestamp credential.

The beneficial effect of the further embodiment is as follows: an acquisition service module does not acquire the acquired data to reduce an acquisition amount, and the acquisition service module adopts a three-retry mechanism to ensure the efficiency of data acquisition.

Further, the acquisition subsystem includes an acquisition service module, a DCC generation service module, and a trusted timestamp affixing service module;
the acquisition service module is connected to a KCDB website via the Internet and is configured to provide a capability of acquiring data from the KCDB website of the Bureau International des Poids et Mesures;
the DCC generation service module is configured to generate a digital calibration certificate, parse calibration and measurement capability data, and analyze a unique identifier of the data, which serves as a unique traceability identifier to the KCDB; and is also configured to analyze calibration fields to which the data belongs, including physics, ionizing radiation, and biology and chemistry, and generate a corresponding digital calibration certificate based on built-in digital calibration certificate templates for the calibration field types; and
the trusted timestamp affixing service module is configured to provide and affix a trusted timestamp and generate a trusted timestamp credential by calling a trusted timestamp interface based on contents of the digital calibration certificate.

Further, the message queue subsystem is provided with a message queue, and the message queue adopts inter-process message queue services, including a data acquisition request queue, an acquisition result return queue, and a data acquisition log queue;
the data acquisition request queue is configured to transmit acquisition start information from the business data management module to the acquisition service module;
the acquisition result return queue is configured to transmit acquired result information from the acquisition service module to the business data management module; and
the data acquisition log queue is configured to transmit a log message from the acquisition service module to the business data management module.

Further, the storage subsystem is provided with a database; and

the database stores information and data in the processing process with a relational database, including a user information table, a permission information table, a calibration and measurement capability data table, a digital calibration certificate data table, a trusted timestamp credential data table, and a log information acquisition table.

A method for embedding machine-readable calibration and measurement capability data into a DCC is applied to the system for embedding machine-readable calibration and measurement capability data into the DCC, and includes the following steps:
S1. acquiring calibration and measurement capability data after a latest publication time according to a publication time of acquired data;
S2. generating a digital calibration certificate according to acquired business data;
S3. affixing a trusted timestamp according to contents of the generated digital calibration certificate, and generating a trusted timestamp credential; and
S4. storing the calibration and measurement capability data, the digital calibration certificate, and the trusted timestamp credential.

Further, in the S1, the method for acquiring the calibration and measurement capability data specifically includes:
according to an official API KCDB manual issued by the Bureau International des Poids et Mesures, acquiring the calibration and measurement capability data in a specified time range with a three-retry mechanism.

Further, the S2 specifically includes:
analyzing a unique identifier of the calibration and measurement capability data, which serves as a unique traceability identifier to the KCDB, analyzing calibration fields to which the data belongs, including physics, ionizing radiation, and biology and chemistry, and generating a corresponding digital calibration certificate based on built-in digital calibration certificate templates for the three calibration field types.

Further, the S3 specifically includes:
calculating SHA256 values according to the contents of the generated digital calibration certificate as fingerprint information of the data, and receiving a returned trusted timestamp credential by calling a trusted timestamp interface, wherein the trusted timestamp interface is provided by an authorized affixing institution for trusted timestamps.

Further, in the S4, the calibration and measurement capability data is stored in a raw data table, the digital calibration certificate is stored in a DCC data table, and the trusted timestamp credential is stored in a trusted timestamp credential table.

The beneficial effects of the present application are as follows:
(1) The present application provides a system and a method for embedding machine-readable calibration and measurement capability data into a DCC, which regularly acquires the calibration and measurement capability data from a BIPM website, embeds the calibration and measurement capability data into a relevant digital calibration certificate, and generates a trusted timestamp for the digital calibration certificate. The calibration and measurement capability data in the KCDB are regularly acquired and dynamically updated through API calling, so that a traditional manual query mode is replaced, manual intervention is remarkably reduced, the accuracy, effectiveness and authority of data use are improved, and the user experience is greatly improved.
(2) According to the present application, the relevant calibration and measurement capability data in the XML format is embedded into the digital calibration certificate to support the provision of the digital calibration certificate within the scope of CIPM MRA, and the digital calibration certificate is directly traced to the Bureau International des Poids et Mesures, so that the competitiveness of a customer product can be improved, the authority and the reliability of calibration institutions that issue the DCC can be enhanced, the generation efficiency and the application value of the digital calibration certificate are greatly improved, and the digital and intelligent development the field of metrology is promoted.

### BRIEF DESCRIPTION OF THE DRAWINGS

FIG. 1 is a schematic diagram I of a system for embedding machine-readable calibration and measurement capability data into a DCC.

FIG. 2 is a schematic diagram II of a system for embedding machine-readable calibration and measurement capability data into a DCC.

FIG. 3 is a flow chart of a method for embedding machine-readable calibration and measurement capability data into a DCC.

Reference numerals: m01. WEB service subsystem; m02. acquisition subsystem; m03. message queue subsystem; m04. storage subsystem; 101. PC; 102. KCDB website; 201. local area network; 202. Internet; 311. WEB API service module; 312. user management module; 313. business data management module; 321. acquisition service module; 322. DCC generation service module; 323. trusted timestamp affixing service module; 331. message queue; and 341. database.

### DESCRIPTION OF EMBODIMENTS

The following description of the specific embodiments of the present application is provided to facilitate the understanding of the present application by those skilled in the art, however, it should be understood that the present application is not limited to the scope of the specific embodiments, and for those of ordinary skill in the art, various changes that are made without departing from the spirit and scope of the present application as defined and determined by the appended claims are apparent, and all inventions and creations that are made by using the concept of the present application are within the protective scope.

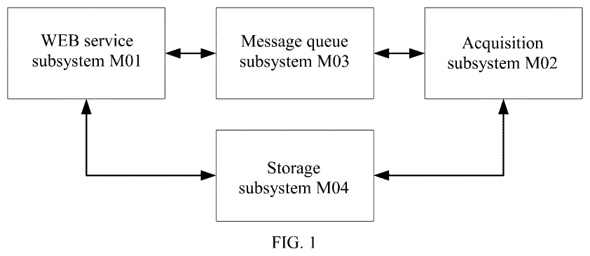

As shown in FIG. 1, in an embodiment of the present application, a system for embedding machine-readable calibration and measurement capability data into a DCC includes a WEB service subsystem M01, an acquisition subsystem M02, a message queue subsystem M03 and a storage subsystem M04, wherein the WEB service subsystem M01 is connected to the acquisition subsystem M02 through the message queue subsystem M03, and the storage subsystem M04 is connected to both the WEB service subsystem M01 and the acquisition subsystem M02.

The WEB service subsystem M01 is configured to online view and manage calibration and measurement capability (CMC) data, a digital calibration certificate (DCC), and trusted timestamp data.

In this embodiment, the WEB service subsystem M01 provides an Ethernet WEB service based on HTTPS for user WEB login.

The acquisition subsystem M02 is configured to acquire data from a BIPM website, regularly acquire calibration and measurement capability data based on acquisition configuration, generate a digital calibration certificate based on an acquisition result, and affix a trusted timestamp.

The message queue subsystem M03 is configured to perform asynchronous communication between the WEB service subsystem M01 and the acquisition subsystem M02.

In this embodiment, the message queue subsystem M03 improves the user response experience by decoupling a relationship between the subsystems.

The storage subsystem M04 is configured to store information and data processed by the WEB service subsystem M01 and the acquisition subsystem M02, and provide corresponding information and data for processing the subsystems.

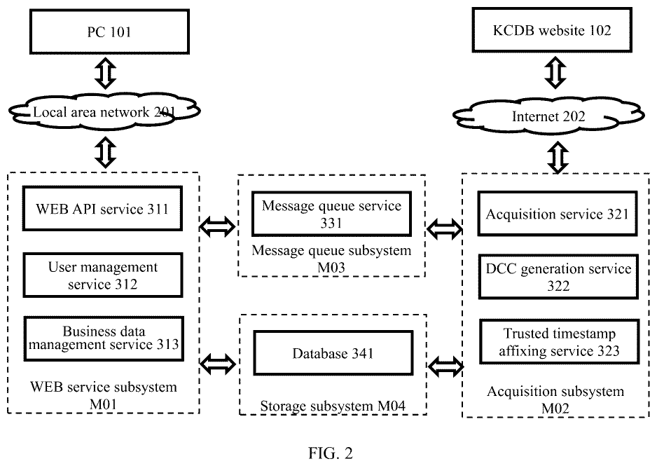

As shown in FIG. 2, the WEB service subsystem M01 includes a WEB API service module 311, a user management module 312, and a business data management module 313;

The WEB API service module 311 is deployed in a local area network 201, and the local area network 201 is connected to a PC (personal computer) 101 and is configured to provide a WEB page service for a user and provide a reverse proxy service of an interface for the user management module 312 and the business data management module 313. Specifically, the user can view and manage the system through a browser.

In this embodiment, the local area network 201 is a KCDB website, which is a website system managed by the Bureau International des Poids et Mesures (BIPM), and provides an external query scope of the Key Comparison Database (KCDB), including a web query and an interface query. The PC 101 is a personal computer in the same local area network as the system and needs to provide web browser support.

The user management module 312 is configured to provide user management services, including user addition, deletion, modification and query, provide user login, logout and authentication services; and is also configured to acquire an authorization scheme based on Cookie and Session, and provide an authorized user with access to corresponding data resource services. Only the authorized user can access the corresponding data resource.

The business data management module 313 is configured to provide management services for business data, including query and deletion of calibration and measurement capability data, query and deletion of digital calibration certificate data, and query of a trusted timestamp credential.

The acquisition subsystem M02 includes an acquisition service module 321, a DCC generation service module 322, and a trusted timestamp affixing service module 323.

The acquisition service module 321 is connected to a KCDB website 102 via the Internet 202 and is configured to provide a capability of acquiring data from the KCDB website 102 of the Bureau International des Poids et Mesures.

In this embodiment, the acquisition service module 321 does not acquire the acquired data to reduce an acquisition amount, and the acquisition service module 321 adopts a three-retry mechanism to ensure the efficiency of data acquisition.

The DCC generation service module 322 is configured to generate a digital calibration certificate, parse calibration and measurement capability data, and analyze a unique identifier of the data, which serves as a unique traceability identifier to the KCDB; and is also configured to analyze calibration fields to which the data belongs, including physics, ionizing radiation, and biology and chemistry, and generate a corresponding digital calibration certificate based on built-in digital calibration certificate templates for the calibration field types.

The trusted timestamp affixing service module 323 is configured to provide and affix a trusted timestamp and generate a trusted timestamp credential by calling a trusted timestamp interface based on contents of the digital calibration certificate.

The message queue subsystem M03 is provided with a message queue 331, and the message queue 331 adopts inter-process message queue services, including a data acquisition request queue, an acquisition result return queue, and a data acquisition log queue.

The data acquisition request queue is configured to transmit acquisition start information from the business data management module 313 to the acquisition service module 321.

The acquisition result return queue is configured to transmit acquired result information from the acquisition service module 321 to the business data management module 313.

The data acquisition log queue is configured to transmit a log message from the acquisition service module 321 to the business data management module 313.

The storage subsystem M04 is provided with a database 341.

The database 341 stores information and data in the processing process with a relational database, including a user information table, a permission information table, a calibration and measurement capability data table, a digital calibration certificate data table, a trusted timestamp credential data table, and a log information acquisition table.

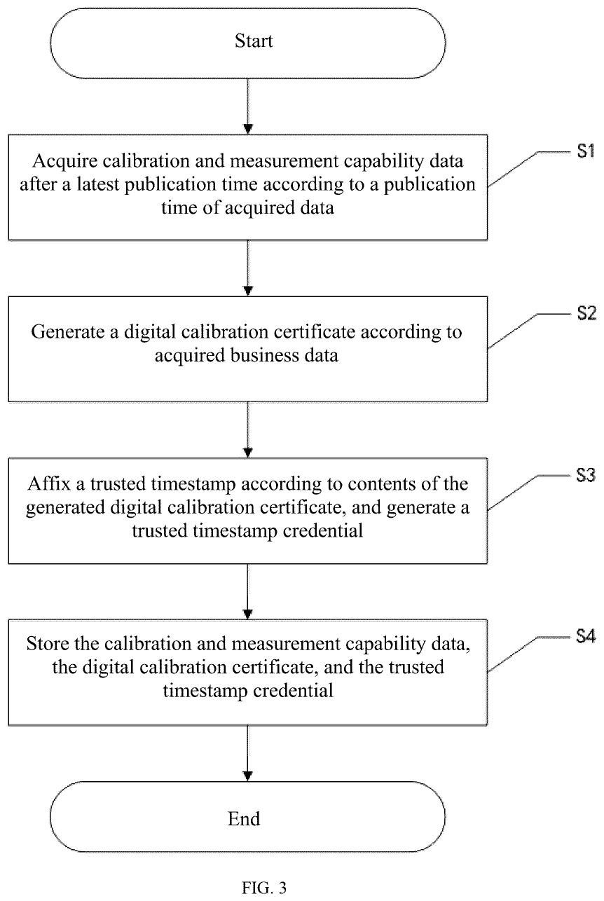

As shown in FIG. 3, a method for embedding machine-readable calibration and measurement capability data into a DCC is applied to the system for embedding machine-readable calibration and measurement capability data into the DCC, and includes the following steps:
S1. acquiring calibration and measurement capability data after a latest publication time according to a publication time of acquired data;
S2. generating a digital calibration certificate according to acquired business data;
S3. affixing a trusted timestamp according to contents of the generated digital calibration certificate, and generating a trusted timestamp credential; and
S4. storing the calibration and measurement capability data, the digital calibration certificate, and the trusted timestamp credential.

In the S1, the method for acquiring the calibration and measurement capability data specifically includes:
according to an official API KCDB manual issued by the Bureau International des Poids et Mesures, acquiring the calibration and measurement capability data in a specified time range with a three-retry mechanism.

In this embodiment, the user can start data acquisition by asynchronous calling on the WEB page, and data acquisition may also be triggered by a background scheduled task to acquire calibration and measurement capability data within a specified time range. Due to the instability factor of the Internet 202, a three-retry mechanism is adopted.

The S2 specifically includes:
analyzing a unique identifier of the calibration and measurement capability data, which serves as a unique traceability identifier to the KCDB, analyzing calibration fields to which the data belongs, including physics, ionizing radiation, and biology and chemistry, and generating a corresponding digital calibration certificate based on built-in digital calibration certificate templates for the three calibration field types.

The S3 specifically includes:
calculating SHA256 values according to the contents of the generated digital calibration certificate as fingerprint information of the data, and receiving a returned trusted timestamp credential by calling a trusted timestamp interface, wherein the trusted timestamp interface is provided by an authorized affixing institution for trusted timestamps.

In the S4, the calibration and measurement capability data is stored in a raw data table, the digital calibration certificate is stored in a DCC data table, and the trusted timestamp credential is stored in a trusted timestamp credential table.

The beneficial effects of the present application are as follows: The present application provides a system and a method for embedding machine-readable calibration and measurement capability data into a DCC, which regularly acquires the calibration and measurement capability data from a BIPM website, embeds the calibration and measurement capability data into a relevant digital calibration certificate, and generates a trusted timestamp for the digital calibration certificate. The calibration and measurement capability data in the KCDB are regularly acquired and dynamically updated through API calling, so that a traditional manual query mode is replaced, manual intervention is remarkably reduced, the accuracy, effectiveness and authority of data use are improved, and the user experience is greatly improved.

According to the present application, the relevant calibration and measurement capability data in the XML format is embedded into the digital calibration certificate to support the provision of the digital calibration certificate within the scope of CIPM MRA, and the digital calibration certificate is directly traced to the Bureau International des Poids et Mesures, so that the competitiveness of a customer product can be improved, the authority and the reliability of calibration institutions that issue the DCC can be enhanced, the generation efficiency and the application value of the digital calibration certificate are greatly improved, and the digital and intelligent development the field of metrology is promoted.

In the description of the present application, it should be understood that directions or positional relationships indicated by the terms “center”, “thickness”, “upper”, “lower”, “horizontal”, “top”, “bottom”, “inner”, “outer”, “radial”, and the like are those shown based on the accompanying drawings, and are merely intended to facilitate and simplify description rather than indicate or imply that the indicated device or element must have a specific direction and must be configured and operated according to the specific direction. Therefore, these directions or positional relationships should not be construed as limiting the present application. Furthermore, the terms “first”, “second”, or “third” are merely intended for a purpose of description, and shall not be understood as an indication or implication of relative importance or an implicit indication of a quantity of indicated technical features. Therefore, a feature defined with “first”, “second”, or “third” may explicitly or implicitly include one or more such features.

What is claimed is:

1. A system for embedding machine-readable calibration and measurement capability data into a DCC, comprising a WEB service subsystem, an acquisition subsystem, a message queue subsystem, and a storage subsystem, wherein the WEB service subsystem is connected to the acquisition subsystem through the message queue subsystem, and the storage subsystem is connected to both the WEB service subsystem and the acquisition subsystem;
the WEB service subsystem is configured to online view and manage calibration and measurement capability data, a digital calibration certificate, and trusted timestamp data;
the acquisition subsystem is configured to acquire data from a Bureau International des Poids et Mesures website, regularly acquire calibration and measurement capability data based on acquisition configuration, generate a digital calibration certificate based on an acquisition result, and affix a trusted timestamp;
the acquisition subsystem comprises an acquisition service module, a DCC generation service module, and a trusted timestamp affixing service module; wherein the acquisition service module is connected to a Key Comparison Database website via the Internet, and is configured to provide a capability of acquiring data from the KCDB website of the Bureau International des Poids et Mesures;
the DCC generation service module is configured to generate a digital calibration certificate, parse calibration and measurement capability data, and analyze a unique identifier of the data, which serves as a unique traceability identifier to the KCDB; and is also configured to analyze calibration fields to which the data belongs, comprising physics, ionizing radiation, and biology and chemistry, and generate a corresponding digital calibration certificate based on built-in digital calibration certificate templates for the calibration field types;
the trusted timestamp affixing service module is configured to provide and affix a trusted timestamp and generate a trusted timestamp credential by calling a trusted timestamp interface based on contents of the digital calibration certificate;
the message queue subsystem is configured to perform asynchronous communication between the WEB service subsystem and the acquisition subsystem; and
the storage subsystem is configured to store information and data processed by the WEB service subsystem and the acquisition subsystem.

2. The system for embedding machine-readable calibration and measurement capability data into the DCC according to claim 1, wherein the WEB service subsystem comprises a WEB API service module, a user management module, and a business data management module;
the WEB API service module is deployed in a local area network, and the local area network is connected to a PC (personal computer) and is configured to provide a WEB page service for a user and provide a reverse proxy service of an interface for the user management module and the business data management module;
the user management module is configured to provide user management services, comprising user addition, deletion, modification and query, provide user login, logout and authentication services; and is also configured to acquire an authorization scheme based on Cookie and Session and provide an authorized user with access to corresponding data resource services; and
the business data management module is configured to provide management services for business data, comprising query and deletion of calibration and measurement capability data, query and deletion of digital calibration certificate data, and query of a trusted timestamp credential.

3. The system for embedding machine-readable calibration and measurement capability data into the DCC according to claim 1, wherein the message queue subsystem is provided with a message queue, and the message queue adopts inter-process message queue services, comprising a data acquisition request queue, an acquisition result return queue, and a data acquisition log queue;
the data acquisition request queue is configured to transmit acquisition start information from a business data management module to the acquisition service module;
the acquisition result return queue is configured to transmit acquired result information from the acquisition service module to a business data management module; and
the data acquisition log queue is configured to transmit a log message from the acquisition service module to a business data management module.

4. The system for embedding machine-readable calibration and measurement capability data into the DCC according to claim 1, wherein the storage subsystem is provided with a database ; and
the database stores information and data in the processing process with a relational database, comprising a user information table, a permission information table, a calibration and measurement capability data table, a digital calibration certificate data table, a trusted timestamp credential data table, and a log information acquisition table.

5. A method for embedding machine-readable calibration and measurement capability data into a DCC, applied to the system for embedding machine-readable calibration and measurement capability data into the DCC according to claim 1, and comprising the following steps:
S1. acquiring calibration and measurement capability data after a latest publication time according to a publication time of acquired data;
S2. generating a digital calibration certificate according to acquired business data;
S3. affixing a trusted timestamp according to contents of the generated digital calibration certificate, and generating a trusted timestamp credential; and
S4. storing the calibration and measurement capability data, the digital calibration certificate, and the trusted timestamp credential.

6. The method for embedding machine-readable calibration and measurement capability data into the DCC according to claim 5, wherein in the S1, the method for acquiring the calibration and measurement capability data specifically comprises:
according to an official API KCDB manual issued by the Bureau International des Poids et Mesures, acquiring the calibration and measurement capability data in a specified time range with a three-retry mechanism.

7. The method for embedding machine-readable calibration and measurement capability data into the DCC according to claim 5, wherein the S2 specifically comprises:
analyzing a unique identifier of the calibration and measurement capability data, which serves as a unique traceability identifier to the KCDB, analyzing calibration fields to which the data belongs, comprising physics, ionizing radiation, and biology and chemistry, and generating a corresponding digital calibration certificate based on built-in digital calibration certificate templates for the three calibration field types.

8. The method for embedding machine-readable calibration and measurement capability data into the DCC according to claim 7, wherein the S3 specifically comprises:
calculating SHA256 values according to the contents of the generated digital calibration certificate as fingerprint information of the data, and receiving a returned trusted timestamp credential by calling a trusted timestamp interface, wherein the trusted timestamp interface is provided by an authorized affixing institution for trusted timestamps.

9. The method for embedding machine-readable calibration and measurement capability data into the DCC according to claim 5, wherein in the S4, the calibration and measurement capability data is stored in a raw data table, the digital calibration certificate is stored in a DCC data table, and the trusted timestamp credential is stored in a trusted timestamp credential table.
